(19) United States
(12) Patent Application Publication
(10) Pub. No.: US 2026/0137999 A1
(43) Pub. Date: May 21, 2026

(54) ELECTRONIC GAMING CYCLE FOR PACHINKO GAMING MACHINE

(71) Applicant: Amuse d.o.o., Ljubljana (SI)

(72) Inventors: Keiichi KOJIMA, Setagaya (JP); Satoshi JOKO, Sagamihara (JP)

(21) Appl. No.: 19/346,813

(22) Filed: Oct. 1, 2025

Related U.S. Application Data
(60) Provisional application No. 63/703,484, filed on Oct. 4, 2024.

(51) Int. Cl. A63F 7/02; G07F 17/32; G07F 17/38

(52) U.S. Cl. CPC A63F 7/022; G07F 17/3209; G07F 17/3223; G07F 17/3232; G07F 17/3258; G07F 17/3288; G07F 17/38; G07F 17/3211

(57) ABSTRACT

Pachinko gaming systems, methods, and apparatuses are disclosed. A pachinko gaming apparatus may include a communications controller installed in a pachinko gaming machine. The communications controller may execute a pachinko gaming event according to a randomly determined outcome, and exchange gaming information about the gaming event with a remote gaming system monitoring the pachinko gaming event and player activity at the pachinko gaming machine.

### CROSS REFERENCE TO RELATED APPLICATIONS

The present application claims the benefit of U.S. Provisional Patent Application No. 63/703,484, filed Oct. 4, 2024, the entirety of which is incorporated by reference herein.

### TECHNICAL FIELD

The present disclosure relates to gaming apparatus and more particularly to pachinko gaming apparatuses or systems and methods for using the same.

### BACKGROUND

Pachinko machines are popular gaming devices in which players launch metal balls into a vertical playing field, with the goal of landing balls into specific areas or pockets. The playing field has an arrangement of pins and other obstacles that can interact with the balls and provide both entertainment and challenge for the player to land the balls in the specific areas or pockets. When a ball is received in a winning pocket or area, additional balls are awarded to the player and may be redeemed for prizes.

Traditional pachinko machines are fully mechanical machines, with physical obstacles often manually arranged and adjusted to control a gameplay difficulty. Machine maintenance can therefore be time-consuming. It can also be challenging to ensure consistency between machines, as slight variations between obstacle and pocket positioning can significantly affect a difficulty level and win rate associated with a machine.

Pachinko is also traditionally considered a skill-based game, as players can control aspects of a ball launch, such as launch timing and speed using a player-operated elver, which is a common pachinko machine mechanism for releasing a ball into the playing field. Players who are more familiar with a machine's particular operational characteristics and idiosyncrasies may be able to increase their win rate. This can create challenges for a pachinko hall to determine appropriate prizes and payouts, as win rates are not necessarily random, consistent, or predictable.

As the gaming industry becomes increasingly competitive, player experience and gameplay experience also become increasingly important. Familiarity with a game type or machine can cause player interest and engagement to stagnate or decrease over time. Further, many gaming jurisdictions and regulations require gaming machines to operate randomly or according to a particular payout scheme. Due to the physical mechanics and manual operation of the pachinko machine, operating with the required consistency may be difficult and limit where and how pachinko machines are operated. Thus, there is a need for innovations to enhance the gameplay experience and operational aspects of pachinko machines.

### SUMMARY

Pachinko gaming systems and apparatuses are disclosed. In an embodiment, a communications controller may be installed in a pachinko gaming machine. The communications controller is configured to execute a pachinko gaming event according to a randomly determined outcome, and exchange gaming information about the gaming event with a remote gaming system monitoring the pachinko gaming event and player activity at the pachinko gaming machine.

In examples, the communications controller executes the pachinko gaming event and the randomly determined outcome in accordance with Class III gaming requirements. The communications controller may adjust an obstacle on a playing field of the pachinko gaming machine to execute the pachinko gaming event according to the randomly determined outcome. Such adjustments may include controlling access to a pocket to apply a ball receive probability in accordance with a paytable.

In additional examples, the randomly determined outcome may be based on a paytable associated with the pachinko gaming event. The paytable may be provided to the communications controller by the remote gaming system. The randomly determined outcome may be determined by a random number generator. The random number generator may determine at least one of: a ball launch timing, a ball launch speed, an electric tulip, and access to a pocket.

The communications controller may also track, via one or more peripherals of the pachinko gaming machine, game data associated with the pachinko gaming event. The game data comprises at least one of: balls shot, balls won, total balls in a pocket type, total prize won, a total number of games played, and a summary associated with a last set of games.

Additionally, the communications controller may generate graphics associated with the randomly determined outcome on a display associated with the pachinko gaming machine. The pachinko gaming machine may also be operated to eliminate player influence on an outcome pachinko gaming event. In examples, the communications controller operates at least one of: a handle associated with the pachinko machine, a ball launch timing, and a ball launch speed, to effect the randomly determined outcome.

### BRIEF DESCRIPTION OF THE DRAWINGS

FIG. 1 illustrates an example pachinko machine in accordance with an embodiment.

FIG. 2 illustrates an example communications architecture in accordance with an embodiment.

FIG. 3 illustrates a communications controller in accordance with an embodiment.

FIG. 4 illustrates a mechanical architecture in accordance with an embodiment.

FIG. 5A illustrates an example gaming cabinet in accordance with an embodiment.

FIG. 5B illustrates another example gaming cabinet in accordance with an embodiment.

FIG. 5C illustrates another example gaming cabinet in accordance with an embodiment.

FIG. 5D illustrates another example gaming cabinet in accordance with an embodiment.

FIG. 5E illustrates a control panel in accordance with an embodiment.

FIG. 5F illustrates a control panel in accordance with an embodiment.

FIG. 6 illustrates a game flow in accordance with an embodiment.

FIG. 7 illustrates another game flow in accordance with an embodiment.

FIG. 8 illustrates another game flow in accordance with an embodiment.

FIG. 9A illustrates a game operation flow in accordance with an embodiment.

FIG. 9B illustrates another game operation flow in accordance with an embodiment.

FIG. 10A illustrates an electric tulip arrangement in accordance with an embodiment.

FIG. 10B illustrates another electric tulip arrangement in accordance with an embodiment.

FIG. 10C illustrates another electric tulip arrangement in accordance with an embodiment.

FIG. 10D illustrates another electric tulip arrangement in accordance with an embodiment.

FIG. 11A illustrates a reel spin during a base game in accordance with an embodiment.

FIG. 11B illustrates a reel spin during a bonus game in accordance with an embodiment.

FIG. 12A illustrates a handle in accordance with an embodiment.

FIG. 12B illustrates a handle with a shoot pause button in accordance with an embodiment.

FIG. 12C illustrates a smart handle in accordance with an embodiment.

FIG. 13 illustrates a reel spin display in accordance with an embodiment.

FIG. 14 illustrates a game display in accordance with an embodiment.

FIG. 15 illustrates a win combination display in accordance with an embodiment.

FIG. 16 illustrates an error display in accordance with an embodiment.

FIG. 17 illustrates a help screen display in accordance with an embodiment.

FIG. 18 illustrates an audit screen display in accordance with an embodiment.

FIG. 19 illustrates a flow chart in accordance with an embodiment.

FIG. 20 is a block diagram of an embodiment of a computer system.

### DETAILED DESCRIPTION OF ILLUSTRATIVE EMBODIMENTS

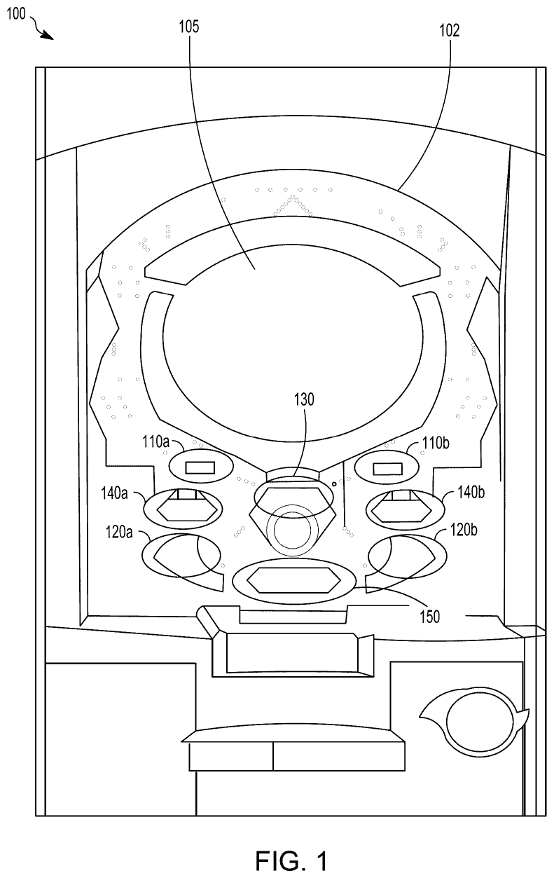

FIG. 1 illustrates an example pachinko machine 100. The pachinko machine includes a playing field 102 with a plurality of obstacles to interact with balls launched onto the playing field, and a display 105 providing gaming information, reels, animations, and the like. The display 105 may provide real-time gaming information, such as indications of one or more pockets that have received a ball, a ball return count, a game status (e.g., base game, bonus game, game over, etc.), wager information, payout information, and the like. In examples, the display may provide at least one of a different graphic, animation, sound, color scheme, and notification for each type of pocket receiving a ball.

During a base game, a ball may be shot using a handle 160. The strength of the ball shoot may change depending on the handle operation. Players may aim for a start pocket 130 to initiate a reel spin. When a ball lands in the start pocket 130, the reel spin may be provided on the display 105. If a predetermined number and type of symbol land on the payline as a result of the reel spin, a bonus is won. The bonus may be a prize, such as a number of balls, a payout, free game, etc. The bonus may also be a game mode, such as a bonus round, in which players have an opportunity to win more balls and prizes. In some examples, during a bonus round, an attacker pocket 150, which provides a higher ball return, may open to provide the player with additional chances to win balls and prizes.

In various examples, one or more through pockets 110a, 110b, may be provided on the pachinko machine 100. The through pockets 110a, 110b may trigger a special feature, such as extra ball launches, bonus games, or prizes, when a ball passes through. In examples,

The start pocket 130, as discussed herein, provides a main target for a ball, during a base game, in order to initiate drawings (e.g., a reel spin) on the display 105. In examples, a ball received in a Start pocket may initiate an opportunity for a drawing via a reel spin and provide a certain number of ball returns e.g., 3 balls for every 1 ball received. In an example, if a first ball triggers a reel spin, and a second ball is received in the start pocket 130 during the reel spin, the spin may be stocked and indicated on the display. In some gaming events, a maximum number of stocked spins (e.g., 3, 4, 5, etc.) may be stored. If a ball is received in the start pocket 130 and a maximum number of stocked spins are already recorded, the ball return prize may be awarded, and no extra drawings or reel spins are made.

Prize pockets 120a, 120b provide a main source of ball return to players during a base game. Since prize pockets are often positioned to have a greater likelihood of receiving balls, the ball return rate for prize pockets may be lower than other types of pockets, such as a start pocket, or pockets accessible via an electric tulip.

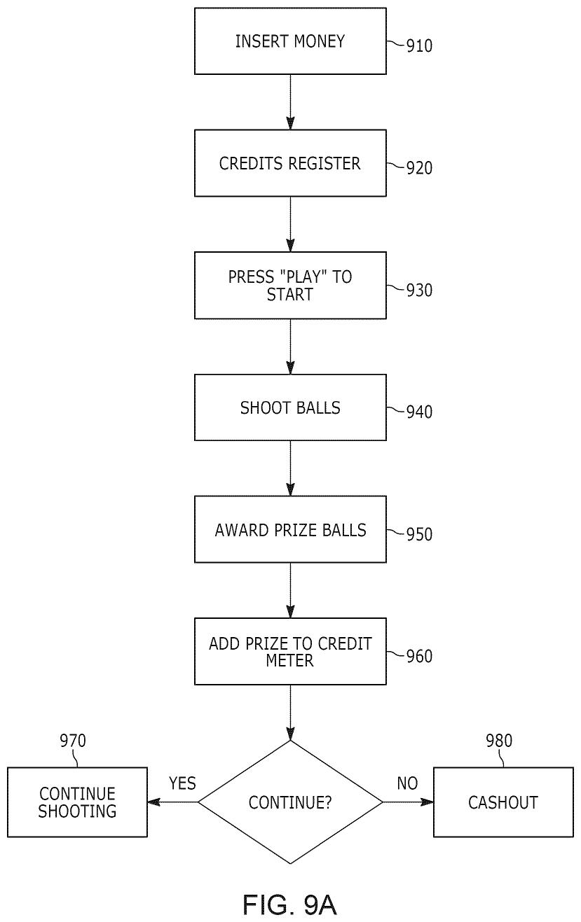

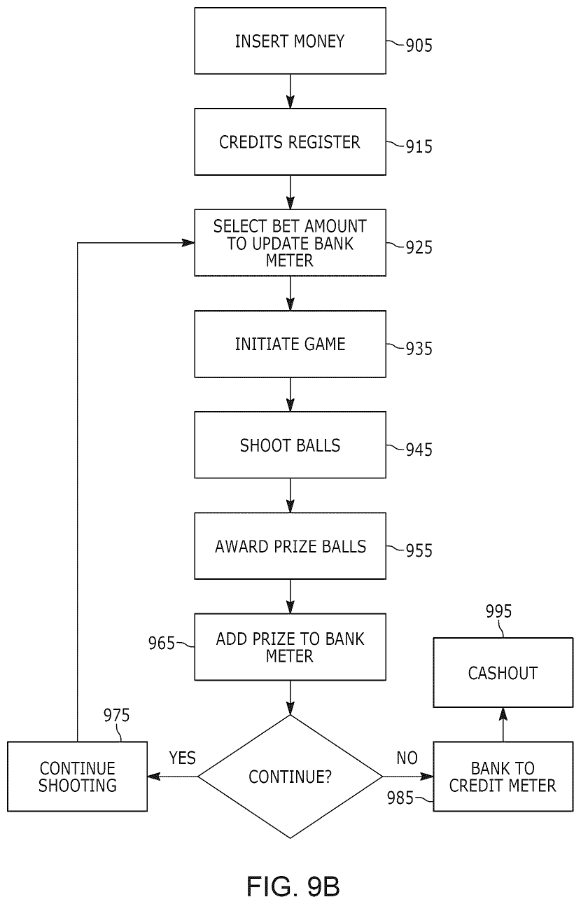

An electric tulip 140 (see also, FIGS. 9A-B, 10A-B) may be activated during a bonus game or in response to a special feature trigger or through pocket hit. The electric tulip 140 may have a hidden pocket, which becomes accessible when the electric tulip is activated and thereby opened. Landing a ball in the electric tulip 140 may cause reels to be spun, e.g., on the display 105, and provide players with additional prizes or chances to win prizes.

An attacker pocket 150 may stay closed during a base game and open during a bonus game. During a period in which the attacker pocket 150 is opened, players will have an opportunity for greater ball returns if they successfully land balls into the attacker pocket.

Gaming events may assign different functions, prizes, and ball returns with each type of pocket. In one example, a start pocket 130 may trigger a reel spin and have a ball return of 1:3, i.e., returning 3 balls for each ball that lands in the start pocket. The start pocket 130 may also be open only during the base game, open both during the base game and a bonus game, or at particular timings during each game type. In an example, the electric tulip 140 may have a 1:3 ball return and cause a reel spin on the display (e.g., display 105) when hit. The electric tulip 140 may only open during a bonus game or other special feature trigger. The prize pocket(s) 120 a, 120 b may have a ball return of 3:4 and provide a source of ball return to players during a base game. In some game variations, the prize pockets provide a return only during the base game. The attacker pocket may have a 10:15 ball return and open during bonus games.

A handle 160 provides a mechanism for a player to shoot balls into the machine. In some examples, the handle 160 can launch balls at different speeds and rates, responsive to a user's operation of the handle 160. Some handles may require users to turn, push, pull, or hit the handle with some force to activate a ball launch. A harder activation hit may launch a ball faster that a soft activation hit. For handles that turn or spin, a faster spin or a greater rotation of the handle may launch a ball faster than slower spins or a lesser rotation. Handle spins may also be directional, wherein a rotation in a certain direction, e.g., to the right or to the left, will initiate a ball launch. In various examples, handles may provide users with tactile feedback or other responsive operation to provide a sense of control and skill when playing the pachinko machine 100. In other machines, ball launches, the speed, rate of launches, etc., may remain randomized to ensure fairness and consistency.

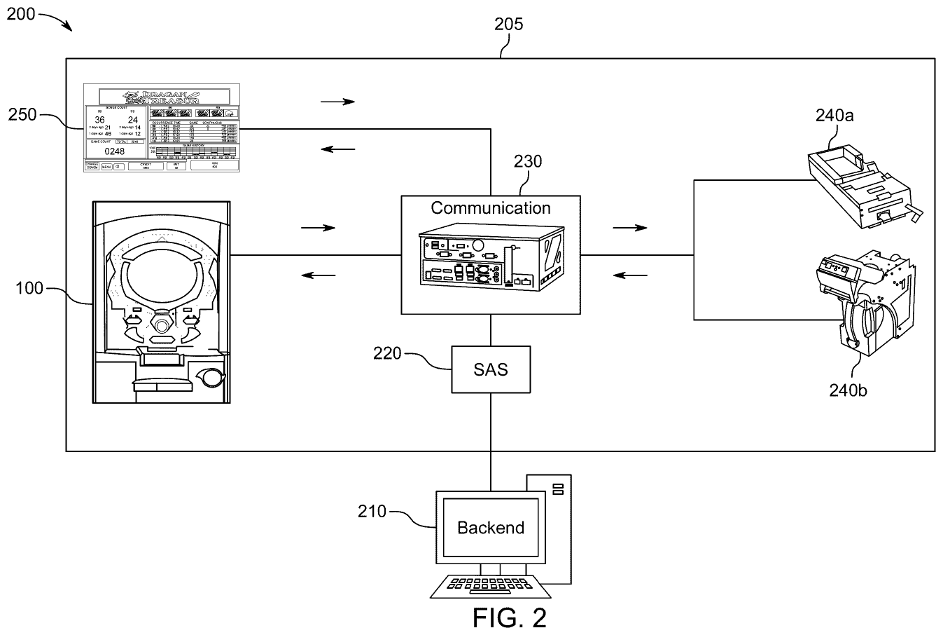

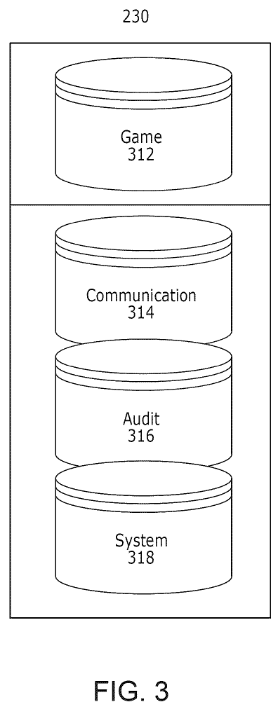

FIG. 2 illustrates an example communications architecture 200 in accordance with various embodiments. The communications architecture may enable pachinko games to be a Class III casino machine. Such machines are related to slot machines, and other game offerings resembling traditional casino games, including but not limited to video poker, roulette, blackjack, craps, and the like. Class III machines utilize a random number generator to determine play outcomes, ensure fairness, and results based on chance. As applied to pachinko machines, the communications architecture enables the traditionally skill-based game to become a Class III machine.

A gaming cabinet 205 may be a Class III gaming cabinet housing the components illustrated in FIG. 2. In some examples, one or more components may be adjacent to or connected, e.g., electronically, physically, wirelessly, etc., to communicate with each other.

The communications architecture 200 and the gaming cabinet 205 supports communications with a backend computing system 210. The backend computing system 210 may track one or more gaming machines on a casino floor and connect, for example, to a casino or gaming location's central monitoring system. The backend system 210 may track, for example, credits in, credits out, credits played, gaming counters, gaming meters, wins, losses, total games played, gaming statistics, errors, alerts, malfunctions, player activities, rewards, and other gaming information associated with the machine. Such communications between components may occur in real-time to provide a live look at gaming activity at one or more gaming machines.

In order to track such metrics, a communications controller 230 provides the primary communication and information relay between the pachinko machine 100, a gaming display 250, and any peripheral devices 240a, 240b associated with the gaming cabinet. The communications controller 230 may include one or more processors and memory storing instructions thereon to execute operations to control communications to and from various devices within the gaming cabinet 205. The communications controller 230 therefore serves as a communication device to process and exchange information between the pachinko machine 100, the gaming display 250, peripherals and the backend system.

In examples, the communications controller 230 may initiate a gaming event and provide gaming data, including sounds, images, feedback, and the like to the pachinko machine 100 and the gaming display 250. The gaming display 250 may be a primary monitor or an additional monitor associated with the pachinko machine 100. The gaming display may also include a touch panel or other interface to receive user input. In examples, the gaming display 250 may provide information to the communications controller 230, such as a display disconnect, a touch panel disconnect, and any information received from a user (e.g., player input. The communications controller 230 may provide information to the gaming display 250, e.g., for display, and such information may include but is not limited to a denomination, a credit meter amount, a bet amount, a win amount, a game count, a bonus count, a help screen graphic, audit metering information, audit event information, and game recall information.

Peripheral 240a may be a device operated by a player to effect one or more gaming actions to initiate a game or during game play, such as a handle, user interface, input device, and the like. Peripheral 240b may components associated with the operation of the gaming cabinet 205, including but not limited to printers, input slots, additional displays, audit meters, game meters, credit meters, and the like. The peripherals may provide information to the communications controller 230, such as ticket in, bill in, error status, event status, ticket out, test, and a request command. The communications controller 230 may provide information to the peripherals such as a ticket out, a test, and a request command.

The communications controller 230 may further provide features and functions not previously realized on traditional pachinko machines. For example, the communications controller 230 may interact with and operate with components to assist and/or operate a bill validator, a printer, an audit meter, game screens, help screens, error and event handling operations, game settings, credit management, wins, payouts, wagers/bets, game tracking, and player tracking. Additional operations that the communications controller 230 may track and communicate include one or more of: a ball in, a ball out, an animation or a movie event (e.g., provided on display 250), active credit information, host information, a spin start, an I/O test, output information, sensor determinations (e.g., magnetic sensor(s) used in the pachinko machine 100), and a cabinet door open/close.

Actions and information occurring at those connected devices are received, compiled, and processed at the communications controller 230, which may communicate directly with a gaming system (e.g., Slot Accounting System (SAS) 220) and the backend computing system 210. In examples, the SAS 220 manages and communicates gaming data between a communication controller 230, the pachinko machine 100, peripherals 240a, 240b, and the backend computing system 210. Together, such features help to enable game tracking, player tracking, accounting information, monitoring, and compliance during operation of gaming events.

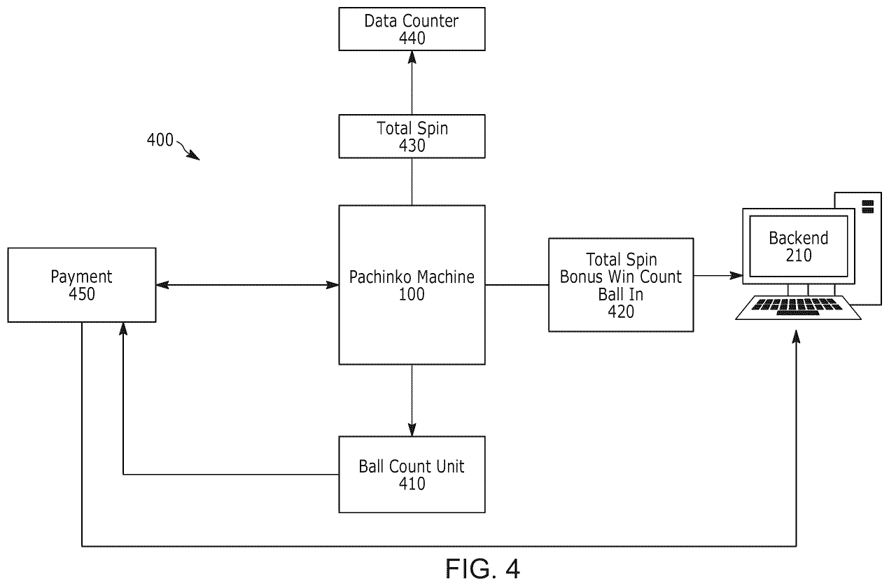

FIG. 4 illustrates an example communications controller in accordance with an embodiment. The communications controller may include a set of software directed to the game 312, communication 314, audit 316, and system 316. The communications controller 230 is designed to be adaptable and interchangeable to various game types. The game software 312 is unique to each game and may be different between different gaming machines (e.g., different pachinko machines) and game types (e.g., pachinko, pachislot, other cabinet games). The software for communication 314, audit 315, and system 318 may be identical or largely similar between various games and machines. Thus, the communications controller 230 enables various game types, designs, and structures to communicate with the backend computing system 210 and enables casinos and gaming locations to integrate, manage, and track all of its gaming devices, and gaming operations in an efficient, centralized manner.

In some examples, the communications controller 230 may be provided on a circuit board installed into a pachinko gaming cabinet, such as cabinet 205. The communications controller 230 therefore enables efficient conversions of standalone, independent gaming systems into an integrated gaming cabinet connected to and in communication with a backend computing system 210.

In some examples, the game software 312 assists in converting information associated with a machine's unique game type into a common format that is readable, accessible, and usable by a backend computer system 210. For example, a pachinko cabinet (e.g., cabinet 205) generates gaming information related to the unique gaming operations and player operations occurring at the cabinet. Such data can include balls in/out, wins/losses, wagers/wins, and the like. The game software 312 processes the raw gaming data, converts the information to a common format, and sends the gaming information to the backend computing system 210.

In an example, the communications controller 230 may receive balls in and balls out data for a round of play of a pachinko game. The communications controller 230 then generates game cycle information, in a common format, using the received information (e.g., balls in/out) from the pachinko game. The game cycle data may then be provided to a backend computing system 210 monitoring gameplay operations at one or more devices. In some examples a converter may be applied to the raw game data (e.g., balls in/out) to create the game cycle information in a common format. The conversion may be done via a software module associated with the communications controller. In some examples, the game software 312 includes the converter to standardize gaming information.

FIG. 4 illustrates communications 400 between various hardware components of a pachinko machine. A pachinko machine 100 may include components associated with payment (e.g., payment unit 450), a ball count unit 410, and a data counter 440. The ball count unit 410 counts the winning balls and sends the information to the payment unit 450. The payment system may include a bill validator and a card unit. The card unit can read, for example, player cards, payment cards, casino cards, loyalty cards, and the like. The payment unit 450 can receive and send accepted bill information to the pachinko machine 100 to control the balance, which may be provided on a display. The payment unit 450 may also record the ball count and balance information to a card (e.g., a player card) or printed on a card issued to the player when the player cashes out. The payment information may also be sent to the backend computing system 210 for additional recordation and bookkeeping. The data counter 440 can show, for example, a current reel spin count and gameplay information such as a bonus amount or a number of bonuses won. The total spin 430 may be determined by a software or hardware module to and the count information may be sent to the data counter.

In an example game flow on the communications architecture of FIG. 4, a player may first insert a bill into the payment unit 450. The bill may be a card, cash, or other form of currency. The bill information transfers to the pachinko machine 100, which will display the value on a monitor. In some examples, the pachinko machine 100 may have a minimum or maximum amount that it may accept (e.g., $1 or $10,000). The player may “rent” or “purchase” a ball via a selection, such as a button or icon on a display screen. In an example, a player may enter $1,000, and purchase a ball for $4/ball. A selection may pay 125 balls (i.e., $500), and the player may choose to purchase more balls or play with the current amount.

The purchases balls are released into a player tray so the player can shoot. If a tray (e.g., an upper tray) becomes full, the balls may overflow to a second location (e.g., a lower tray). If the second location becomes full, a release lever may cause the balls to drop the ball count unit 410. The ball count unit 410 determines the number of balls and the amount is provided to the payment unit 450.

The player can “Cash Out” when they no longer wish to play and the value associated with any remaining balls or payouts are provided to the player via the payment unit 450. As discussed herein, the payment unit 450 may print or generate a card to the player, or otherwise update a player card or player account. The player can then exchange their winnings at a redemption hall.

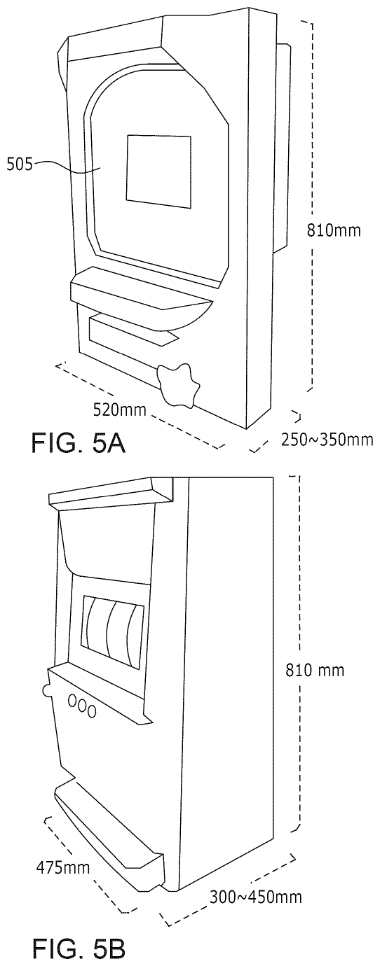

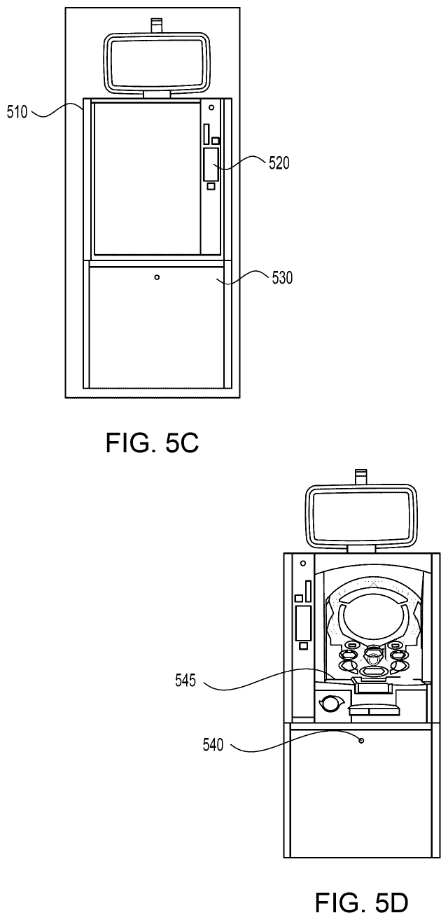

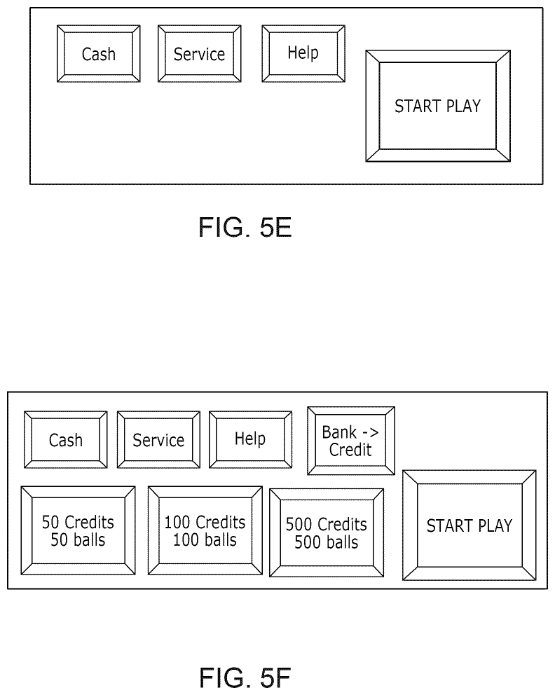

FIGS. 5A-D illustrate example gaming cabinets on which pachinko machines (e.g., pachinko machine 100) may be installed. The cabinets may be standalone cabinets having a common footprint, similar to other gaming cabinets, such as slot gaming cabinets. FIG. 5A shows an example with a recessed display area 505 on which the game may be installed. The cabinet has a length of 520 mm, a width of 250-350 mm, and a height of 810 mm. FIG. 5B illustrates a cabinet similar to a slot machine and sized similarly. In the example, the length may be 475 mm, the width may be 300-450 mm, and the height may be 810 mm. It should be appreciated that the depicted cabinets are merely examples, and cabinet sizes may be larger or smaller in any dimensions, to accommodate appropriate hardware, machinery, and any other design considerations.

FIGS. 5C-D illustrates additional examples of a gaming cabinet for pachinko games. In FIG. 5C, a top portion 510 may be hollow to hold the pachinko machine 100 and any associated displays. Panel 520 may hold at least one of a peripheral devices and a control panel for gaming operations. In some examples, panel 520 contains the printer, the control panel, and a payment unit (e.g., payment unit 450). The control panel may include buttons for Return (e.g., return card or cashout with the balance and information about the number of winning balls, Balance (e.g., showing a balance of a card or an amount available for play on the machine), and Ball Rent (e.g., to initiate a ball rental).

In a bottom section 530, additional hardware to operate the gaming unit may be contained. In examples, the bottom section may include the communications controller (e.g., communications controller 230), wiring, and other hardware associated with gaming operations and communications. The bottom section 530 may include a security door 540 to secure any contained components and prevent damage, cheating, and general access to the components by a player or unauthorized individual. In some examples, the ball tray may have a cover 545, such as a blank plate to prevent players from touching, removing, or accessing the pachinko balls.

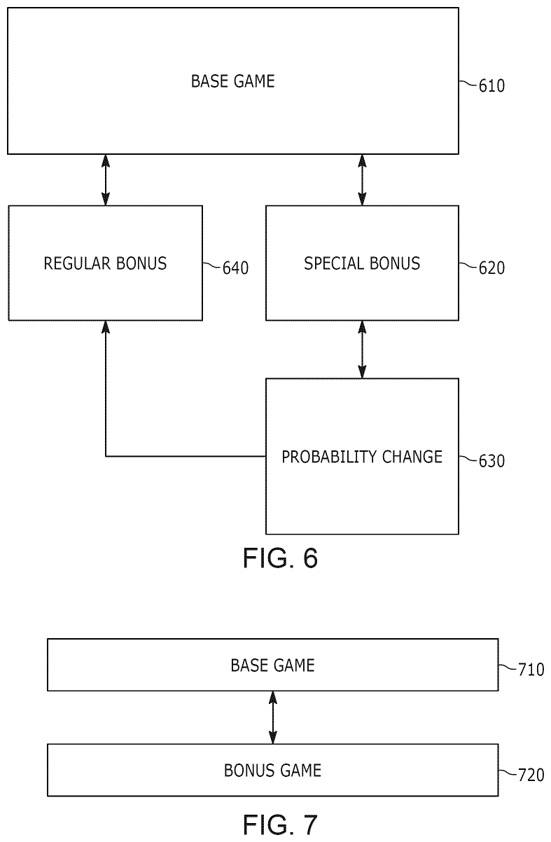

FIGS. 5E-F illustrate gaming control panels which may be installed with the gaming cabinets (e.g., FIGS. 5A-D) to control gaming events. In some examples, the panel may be provided on a ledge or a panel beneath the gaming machine for easy access. In other examples, the control panel may be provided near a handle for shooting the ball. Control buttons may be positioned near each other for ease of access and use. FIG. 5E illustrates a first control panel configuration, having a Cash, Service, Help and Start Play button. In such examples, the control panel may be used with the game flow discussed in FIG. 6. The Cash button provides cashout, the service button requests assistance, the help button brings up game rules and pay tables, and the start play button initiates a round of play. FIG. 5F illustrates an example, which includes buttons for a bet amount, usable with the game flow discussed in FIG. 7. FIG. 5F includes the Cash, Service, Help, and Start Play buttons, and further includes a “Bank→Credit” option and bet amount buttons. In the illustrated example, the bet amount buttons are 50 credits for 50 balls, 100 credits for 100 balls, and 500 credits for 500 balls. However, different bet amounts may be provided, depending on the gaming machine and gaming considerations.

As discussed herein, existing pachinko machines may be installed into such cabinets and integrated with the communications controller to upgrade the gaming experience and transform the game into a Class III gaming machine. As such, various cabinet designs may be applied depending on particular gaming features to be added or removed. For example, “Ball Rent” and “Ball Return” buttons on a traditional pachinko machine may be disabled once installed and integrated with the communications controller. The Shoot button or Pause button may similarly be disabled if it is no longer needed based on the updated pachinko game flow. In some examples, one or more ball trays may be removed if no longer needed, thus reducing the footprint of the pachinko machine to be installed in a cabinet. In some examples, a main board of the pachinko game may be relocated to a logic area, e.g., to satisfy regulatory requirements.

FIG. 6 illustrates an example game flow in accordance with various embodiments discussed herein. A base game 610 may be a pachinko game having a probability associated with a win. For example, the win probability may be 1/300 such that each ball shot has a 1/300 chance of winning.

A winning ball may either trigger a regular bonus 640 or a special bonus 620. In some examples, the type of bonus (regular vs. special) may be determined based on a random number generator and probability associated with each type. In other examples, the special bonus 620 is triggered when a specific bet has been selected and paid for by the user.

The regular bonus may have a different win probability than the base game (e.g., 1/150), and the regular bonus may also have an assigned payout (e.g., a number of balls) associated with a win during the bonus. In some examples, special bonus 620 initiates a probability change 630 associated with the regular bonus, for example, making a win even more likely than in the regular bonus (e.g., 1/100).

In both examples (regular bonus vs. special bonus), the bonus trigger may initiate visual or mechanical changes, such as the opening of one or more tulips on the pachinko board, the opening of additional slots that balls can land in, or a change in sound, animations, colors, and display provided on the pachinko board, the gaming display, and any additional monitors. The bonus rounds may also last a certain length, such as a certain period of time, or for a certain number of balls host. The regular bonus and special bonus may have different characteristics associated with each, and the win probabilities and game changes may differ, depending on the game type (e.g., as defined by gaming software 312).

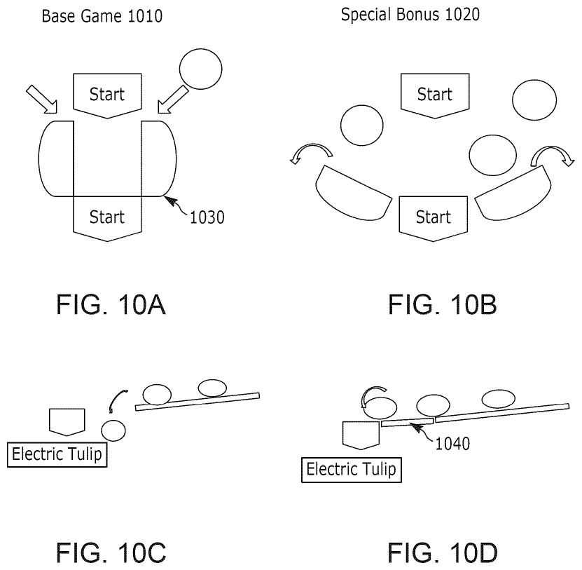

FIG. 7 illustrates another example of a bonus game structure, in which a base game 710 can initiate a bonus game 720. In examples, a pachinko machine may have at least one special slot to catch a ball that initiates bonus game 720. The bonus game 720 may open one or more tulips (see, e.g., FIGS. 10A-D). The tulips may remain open until it receives a predetermined number of balls, such as 10 balls. The bonus game 720 may be set to occur only a set number of times during a gaming event, such as 15 times.

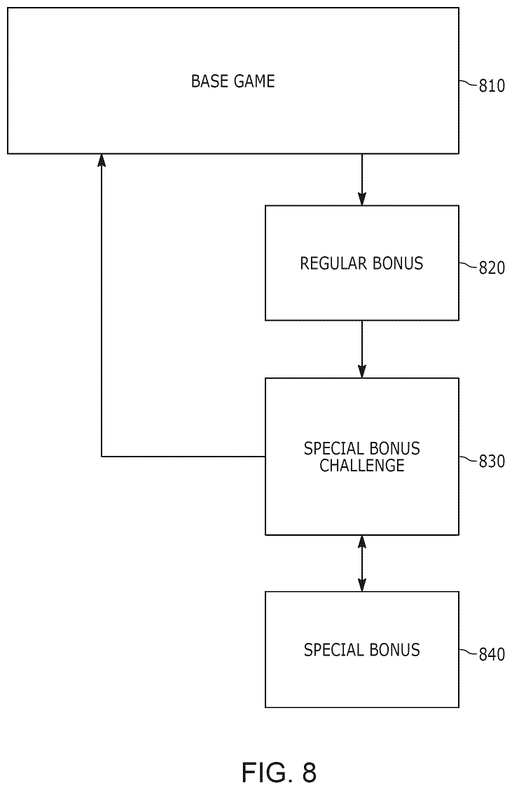

FIG. 8 illustrates another example of a bonus game structure. A base game 810 may have a first probability associated with a win to initiate a regular bonus 820, such as 1/200. During the base game 810, a tulip (see, e.g., FIGS. 10A-D) may be closed, such that a ball cannot reach a hidden pocket. The regular bonus 820 may be associated with a second probability to initiate the special bonus challenge 830, such as 1/100. When the regular bonus is won, the special bonus challenge 830 may open the electric tulip. If a ball is captured in the pocket uncovered by the tulip, a special bonus 840, such as additional balls, is awarded to the player.

FIG. 9A illustrates an operational game flow. The game flow may be applied to pachinko machines operating as a Class III machine, such as pachinko machine 100. In the game flow FIG. 9A, there may be no limitation on a max bet amount. To initiate a round of play, a player inserts money 910 into the pachinko machine. The money may be a cash, a card, or another form of currency acceptable by the pachinko machine. The pachinko machine registers credits 920 and, optionally displays the amount on an attached monitor or display system associated with the machine. A selection of “Play” button 930 starts the game. The “Play” button can be configured to start the game in any of a plurality of ways. For example, the “Play” button may be an operation of a handle, a ball launch button, a selection on an interactive interface, and the like.

Players then shoot balls 940 during gameplay and attempt to land in pockets, earn more balls, initiate bonus rounds, etc., When balls fall into designated pockets the gaming machine awards prize balls 950. The prize balls are added to the credit meter 960, which indicates the amount of balls (i.e., credits) available to shoot.

At any point during the gaming event, players may choose to continue shooting 970 or cashout 980. If players choose to continue shooting 970, they have the opportunity to keep earning awards and additional balls/credits and may keep shooting until the credits become zero. If a player chooses to cashout, this action initiates credit redemption, and the machine may transfer credits via a ticket, a card, a player account, and the like.

FIG. 9B illustrates another operational game flow. In this example, a max bet may be placed for a round of play on the pachinko machine. A player inserts money 905 into the machine, via cash, a card, a player account or another method. The credits register 915 into a “Credit Meter” and the player selects a bet amount to update a “Bank Meter” 925. The bet amount 925 will be deducted from the “Credit Meter” and fund the “Bank Meter,” which may manage the amount of balls available to be shot during a round of play. In examples, the bet amount sets a wager for a round of play, during which a number of balls are shot. Any awards and payouts associated with the number of won balls wills be based on the bet amount.

After the bet amount is registered in the “Banke Meter, the player may initiate the game 935 and shoot balls 945. When balls fall into certain pockets, additional prize balls may be awarded 955 and the value added to the “Bank Meter” 965. The player can choose to continue shooting 975 and can continue to fund the game based on a chosen bet amount, which will be deducted from the “Bank Meter.” If the player chooses not to continue shooting, they can make a selection to transfer the amount in the Bank to the “Credit Meter” 985. Once funds are in the “Credit Meter” the player may cashout 995 and initiate credit redemption, as discussed herein.

In pachinko machines, the return to player value may be set based on controlled access to pockets. Access to a pocket may be controlled via obstacles, which may provide a blocking mechanism to manage how easily a ball can fall into a pocket. In some examples, one or more obstacles may be automatically adjusted (e.g., by controller 230) to assist with managing access to a pocket. Such adjustments may help to standardize a gaming outcome, such as a win rate. In an example, a pair of rods, pins, or an electric tulip positioned above or adjacent to a pocket may be moved or electronically adjusted to assist with controlling whether or not a ball can fall into a pocket. In some examples, a pair of rods positioned above the pocket may be adjusted inwards or outwards to adjust an opening to either allow or block a pathway for the ball to fall into a pocket. FIGS. 10A-D illustrate examples of a tulip mechanism, wherein at least one wing, flap, or bridge may be used to provide or block access to a pocket.

Controlling pocket access enables control of the return to player probability. Different pockets provide different outcomes, such as awarding more balls, awarding a credit, awarding a reel spin, and triggering a bonus round or a bonus game. To create a Class III pachinko machine, a software-based random number may be applied for controlling the pocket access to ensure a return to player payout of a certain range, such as 85-95%.

In examples, the pocket access may be controlled via electric tulips. FIGS. 10A-D illustrate examples of an electric tulip (e.g., electronic tulip 140), in accordance with various embodiments. FIGS. 10A and 10C illustrate a closed electric tulip, e.g., during a base game 1010, and FIGS. 10C and 10D illustrate an open electric tulip, e.g., during a special bonus 1020.

FIGS. 10A-B illustrate an electric tulip having two wings or flaps 1030, which move between a closed position (FIG. 10A) and an open position (FIG. 10B). The closed position prevents balls from reaching the Start pocket. The wings or flaps 1030 open during a triggering event, such as a bonus round, or an activation of a special bonus, to open a pathway for the balls to reach the Start pocket. In some examples, as seen in FIGS. 10A-B, there may be multiple Start pockets provided in a pachinko game. The electric tulip may open to increase the opportunity for a player to win prizes or ball returns associated with the Start pocket.

FIGS. 10C-D illustrate an electric tulip with a bridge 1040 that provides access to the Start pocket. During the closed position, in FIG. 10C, there is no bridge providing a pathway to the pocket. In the open position, the bridge 1040 provides a pathway to the pocket, and balls may roll into the pocket while the bridge is present. In some examples, the bridge may be electronically controlled, e.g., by a controller, to move between a first position that does not enable access to the pocket, and a second position, which creates a path to the pocket.

As discussed herein, electric tulips may be activated during a triggering event such as a special bonus or other special feature in the game. For example, to open the wings/flaps 1030 or activate the bridge 1040, a gaming event may require a ball to go through a Through pocket and win a drawing that is activated by going through a Through pocket. In some examples, the drawing may have a probability associated with a “win.” In some examples, the “win” provides a prize, extra balls, reel spins, a special bonus round, or activation of the electric tulip opening. The Through pocket probability may be 1/50, 1/60, 1/70, 1/80, 1/90, and the like. In some examples, after a special bonus has occurred, the probabilities of the drawings may change and increase (e.g., ¼, ⅕, 1/10, etc.). Thus, after a special bonus, the electric tulips provide access to the start pocket more frequently, and increase a player's opportunity and efficiency for additional balls and prizes.

In addition, although FIGS. 10A-D illustrate examples with an electric tulip guarding a Start pocket, electric tulips may be applied to any type of pocket provided in the pachinko machine.

Additionally, electric tulips help players to spin reels more efficiently. In gaming events, when a ball goes through a specific pocket, such as a “Through” pocket, a player receives a drawing chance. If the player wins the drawing, an electric tulip may open and provide access to a hidden pocket. The hidden pocket can trigger reels.

Reel wins provide another win opportunity, with a controlled return to player payout, based on a random number generator. In examples, the frequency of a win may be determined based on a randomized method, which ensures fairness and consistency.

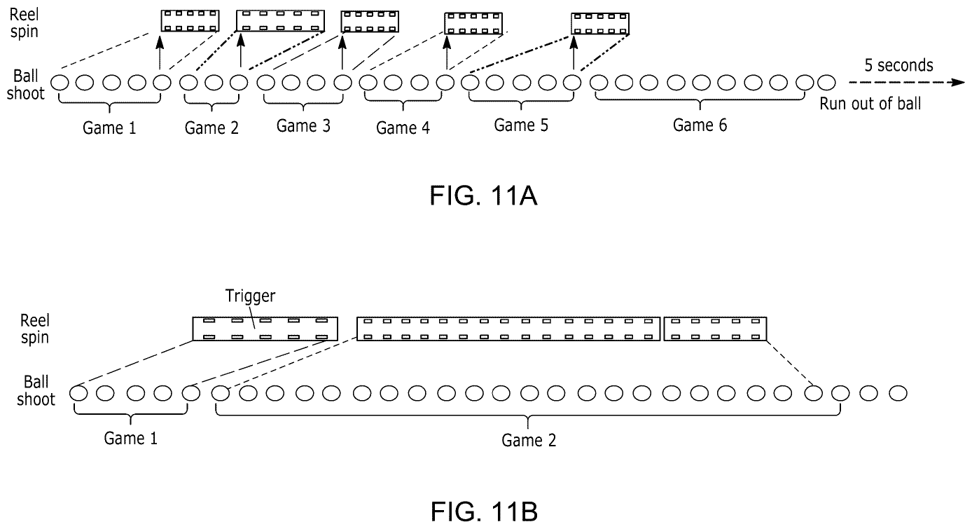

FIGS. 11A-11B illustrate reel spins during a base game (FIG. 11A) and a bonus game (FIG. 11B). In the base game, different pocket types award different ball payouts. For example, the first four balls in Game 1 represent balls being received in a “Lose” pocket, and the last ball received in a “Spin” pocket. In Game 2, the first two balls land in the “Lose” pocket and the last ball lands in the “Spin” pocket. In Game 3, the first and third balls land in the “Lose” pocket, the second ball lands in a “Prize” pocket and the last ball lands in the “Spin” pocket. In Game 4, the first ball lands in “Prize, the second and third balls land in “Lose” and the last ball lands in “Spin. In Game 5, the first four balls land in “Lose” and the last ball lands in “Spin.” In Game 6, the second and sixth balls land in “Prize” and the other balls land in “Lose” The final ball indicates that the player has run out of balls. In the example, the Lose pocket awards no balls, the Spin pocket awards one ball, and the Prize pocket awards three balls. Different pocket types and ball award amounts may be used in analogous pachinko games.

During the game, a reel spin initiates when a ball lands in the Spin pocket. A new Game is also started whenever a ball falls into the “Spin” pocket. In As seen in FIG. 11A, a reel is spun for Games 1-5 because those games have a ball that has landed in the Spin pocket. Reel spins may be randomized to ensure consistency and fairness.

A data counter can track the balls'positions and the reel spin to collect and send gaming data to a backend computing device, such as a central gaming server. Reel information may be sent to the central gaming server whenever a reel is spun. A position of the reel spin may be determined based on a signal from the pachinko machine to the data counter. Winning reel results can be determined based on the tracked or determined position of the reels. Any awards can be paid out based on the reel position, and a new game may be started when the Spin pocket receives the ball.

In FIG. 11B, during a bonus trigger game, a “Spin” pocket may randomly trigger a reel spin. In the bonus rounds, pocket options are “Lose,” “Spin,” “Prize,” and “Attacker.” In Game 1, the first four balls land in the “Lose” pocket and the last ball lands in “Spin,” which triggers a reel spin. In Game 2, an “end” animation for the reel spin may be provided until a final “Spin” pocket receives a ball. When the “Spin” pocket receives the ball, Game 2 and the reel spin both end. A bonus game start signal, reel information, and ball positions may all be provided to the data counter to collect gaming information.

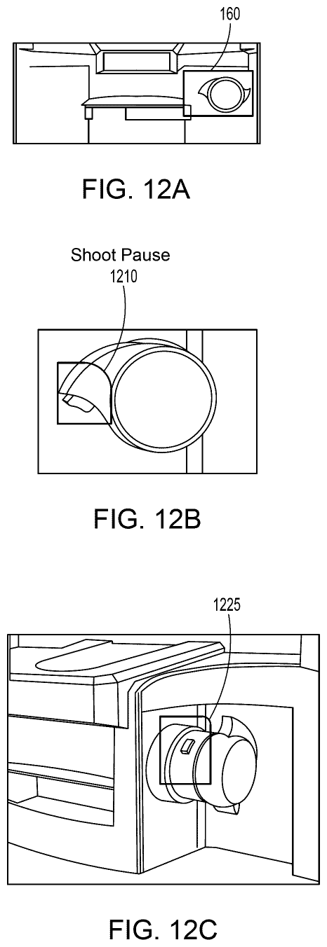

FIGS. 12A-12C illustrate examples of handles usable to shoot balls. FIG. 12A illustrates a handle 160, similar to that described in FIG. 1. The handle 160 may control a strength of the ball shoot, based on a direction that the handle is turned. For example, a left turn may cause a weak ball shot, and a right turn causes a strong ball shot. If a player turns a handle in either direction then releases the handle, the handle will go back to a central, neutral position. Turning the handle from the neutral position and holding the handle will cause balls to continuously shoot at the strength defined by the turn (e.g., weak shot for a left turn, and strong shot for a right turn). In some examples, a handle may have left and right-hand operations, to provide control, regardless of a player's handedness (FIG. 12C).

In some examples, as seen in FIG. 12B, the handle 160 may include a shoot pause button 1210. Selecting shoot pause button 1210 stops the shooting of balls while the player is pressing the button. The shoot pause button 1210 may be located on a back side of the handle or placed at other positions on the handle or on the pachinko machine. The shoot pause button 1210 may be useful for players to save balls and prevent shooting for a period of time.

The shoot pause is a strategic feature for many players. During an animation or a gaming event movie, a player may want to pause shooting to watch the animation and enjoy the experience. When a Spin Stock reaches its maximum (e.g., 4 stocks), a player may also want to stop shooting until a stock slot opens up. This would allow players to increase their opportunities for drawings and reduce wasting a potential Spin win when the Spin Stock is full. A player may also want to initiate the shoot pause button until a special bonus triggers an electric tulip to open. A player may stop shooting while the tulip's wings are closed and begin shooting once they open to receive balls.

FIG. 12C illustrates another handle variation, a smart handle, with a handle 1225 on a left side and right side of the device. Each handle 1225 may be controlled similarly to handle 160. The two-sided device enables players to control the game with either hand, or both hands, if desired. Two shoot pause buttons 1210 centrally located on the handle provide a player with flexibility and options for selecting the button. Such configurations may be ergonomically designed and enable players to play for longer, since they can alternate hands, and have more options to control the game.

To increase randomization and meet Class III requirements, handles may have a standard ball shoot strength for consistent shooting. In some examples, the handle shoots a ball at a same strength (i.e., velocity) regardless of how far the player turns the handle. In some examples, the handle may be applied with a tension mechanisms to increase resistance the farther the handle is turned, and to provide tactile feedback to the player when controlling the handle.

In some examples, the tactile feedback may be adjusted in accordance with a gaming outcome, such as a randomized gaming outcome, in order to convey a sense of control to the player. For example, a first ball launch in accordance with a randomly determined outcome may be a soft ball launch at a particular timing. The tactile feedback may cause the handle or launch mechanism to turn easily or to move a certain distance before the ball launches. A strong ball launch may cause tactile feedback in which the player feels tension when turning or moving the handle. Such changes may occur randomly, or in accordance with different ball launch timings and velocities, as determined by the randomly determined outcome of the gaming event.

In some examples, a handle may shoot at a first strength (e.g., 4/10) during a base game, and shoot at a second strength (e.g., 10/10, or a maximum strength) during a bonus game. In other examples, the shoot pause may be initiated when the player releases the handle. In other words, balls stop shooting upon release of the handle.

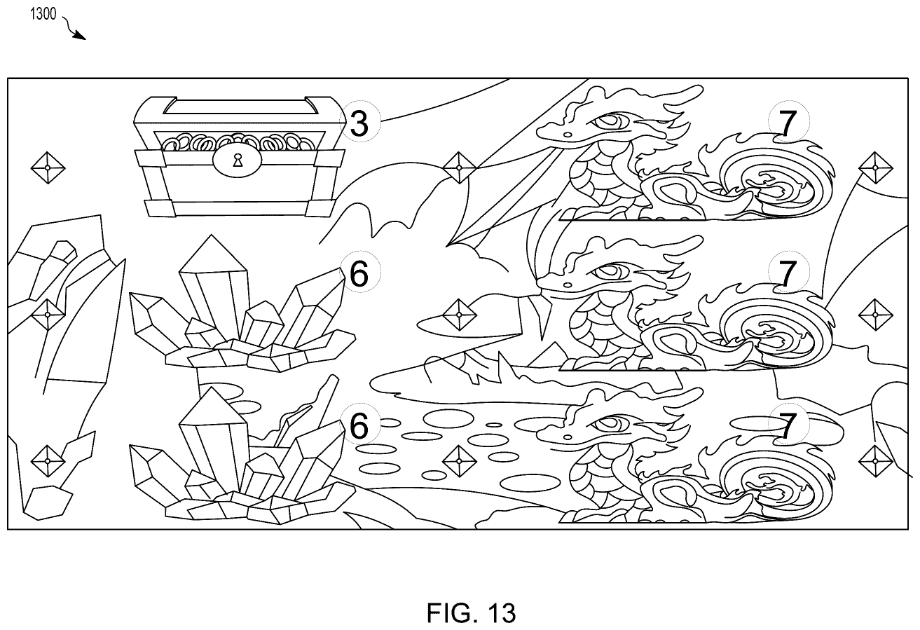

FIGS. 13-18 illustrate example gaming interfaces, which may be provided on a pachinko machine, such as on a user display (e.g., gaming display 250). FIG. 13 illustrates and example of a reel spin win 1300, in accordance with examples discussed herein. In the illustrated example, when three matching symbols align on the reel, the player wins a bonus. In some games, the matching symbols will initiate a bonus round, additional balls, and/or a payout.

In additional examples, a second symbol, such as a number may be associated with each symbol. In FIG. 13, the turtle symbols are associated with 3, the shark symbols are associated with 4, and the lobster symbol is associated with 5. A bonus may be awarded based on the alignment of the second symbols. For example, an alignment of 3 odd number symbols may initiate a special bonus, and an alignment of 3 even number symbols may initiate a regular bonus. As discussed herein, the special bonus may initiate a probability change for a win (see, e.g., FIG. 6A). During a bonus from a reel spin, one or more hidden pockets may become available and one or more electric tulips may be configured to open as a result of the reel spin.

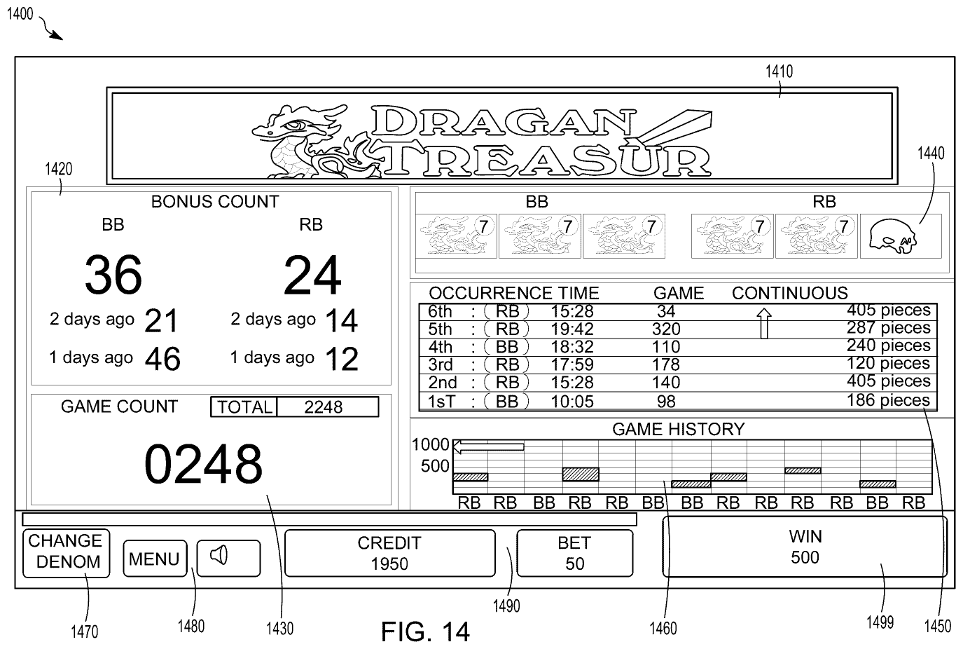

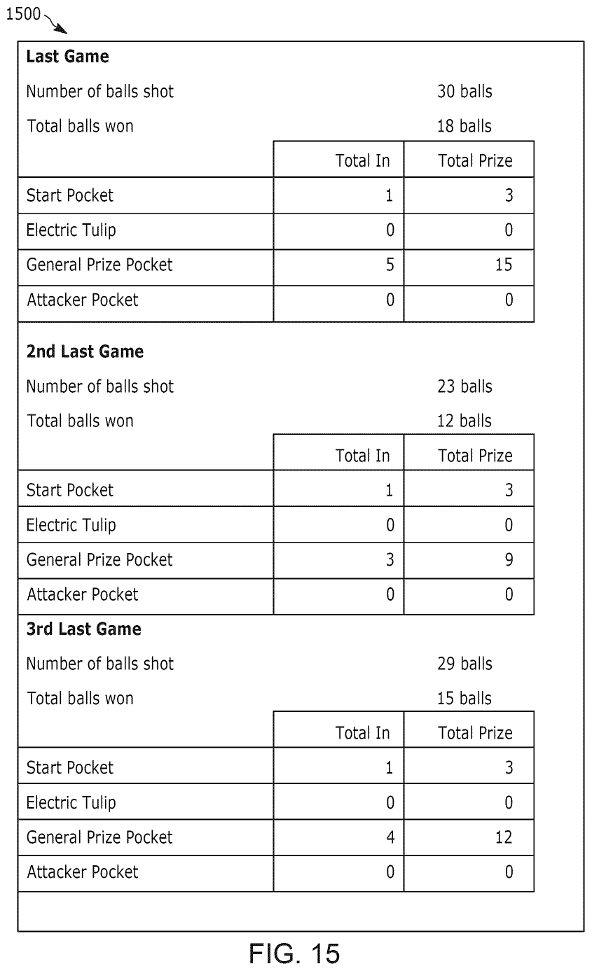

FIG. 14 illustrate an example game display 1400 displaying a plurality of gaming information to the player. In examples, displayed gaming data may relate to Meter, Game, Error, or Audit. Meter related data includes a credit meter, a win meter, a bank meter, and a bet meter. Game related data includes a game instruction message, a win description message, game rules, and pay table information. Error related data includes door events, communication events, call attendant signals, and a lock up message. Audit related data includes metering, an event log, game recall, testing, game settings, communication setting, and peripheral settings.

In FIG. 14, a game title area 1410 displays the name of the game. The title may be provided in one or more languages and include additional information such as version type or other brand information. A section for Past Win Data 1420 displays bonus winning information for a period of time, such as the past three days. A Total Games Played Since Last Bonus 1430 provides information regarding total games played since a last bonus. This information may be obtained from the gaming machine itself.

A central display area may display Win Combination 1440 and a Game Message Area 1450. The Win Combination 1440 may also be determined from the gaming machine and show, for example, a winning reel combination that has been won or needs to be won for a prize. The Game Message Areas 1450 provides various player instructions such as “Win Probability Changes.”

A Slump Graph 1460 provides total games played between the last “N” bonuses. In some gaming displays, the total games played between the last 4, 8, 12, 16, 20 or more games are provided. A Denomination 1470 indicates the denomination equal to one ball cost. A Menu Button 1480 enables a player to change display, audio, and gaming machine settings, such as brightness and volume of the machine. The Credit Meter 1490 displays the total registered credit amounts. The credit amount may show both the credit value and the monetary value. The Bet Meter 1495 displays the total bet amounts by credit and/or monetary value. The Win Meter 1499 displays total win amounts by credit and/or monetary value.

FIG. 15 illustrates a win combination display 1500. The win combination display provides information about a player's past games and win information. In examples, the past three games are displayed, although more or less may be provided. For each game, the win display may provide a total number of balls shot, a total number of balls won, the amount of balls received in different pocket types (e.g., Start, Electric Tulip, Prize, Attacker, etc.), and the Total Prize won from each pocket type.

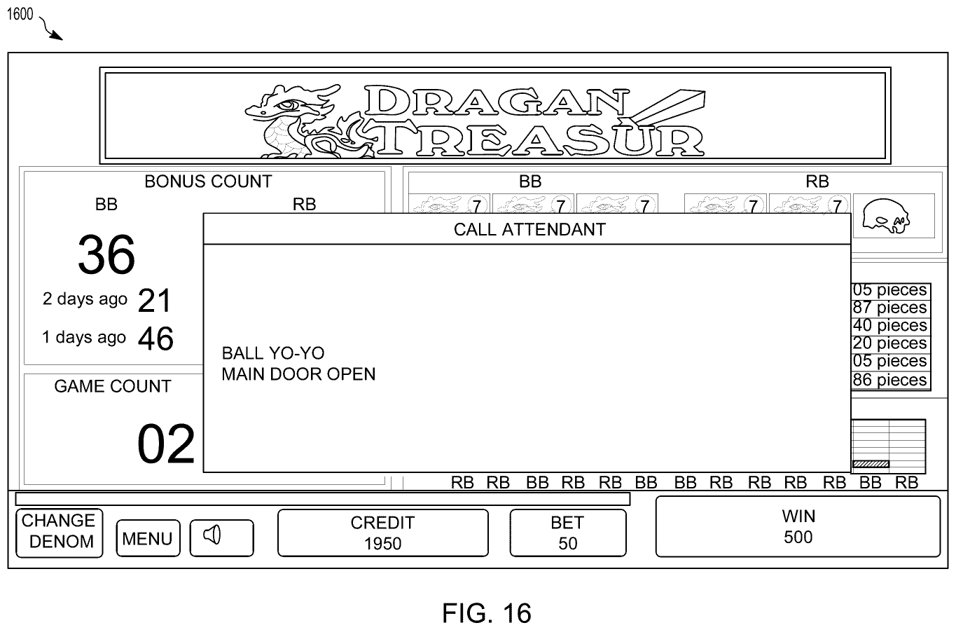

FIG. 16 illustrates an example error display 1600. When an error occurs, such as a ball error, a machine error, a hardware error, or a software error, a window may appear on the display to note the error, and in some cases, a solution for the error. In the illustrated example, a ball yo-yo and a main door open (e.g., of the pachinko machine) caused an error, and the display instructs the user to Call Attendant.

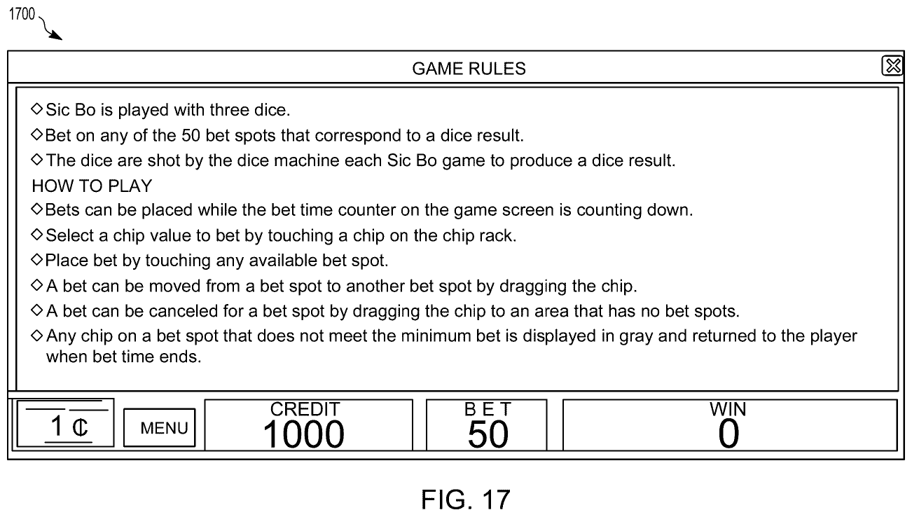

FIG. 17 illustrates a help screen display 1700. In examples, the help screen display 1700 is accessible from a main menu, the gaming screen, or upon selection of a button on the pachinko machine. The help display screen provides information to the player about how to play, what different pockets mean, general game rules, and pay table information.

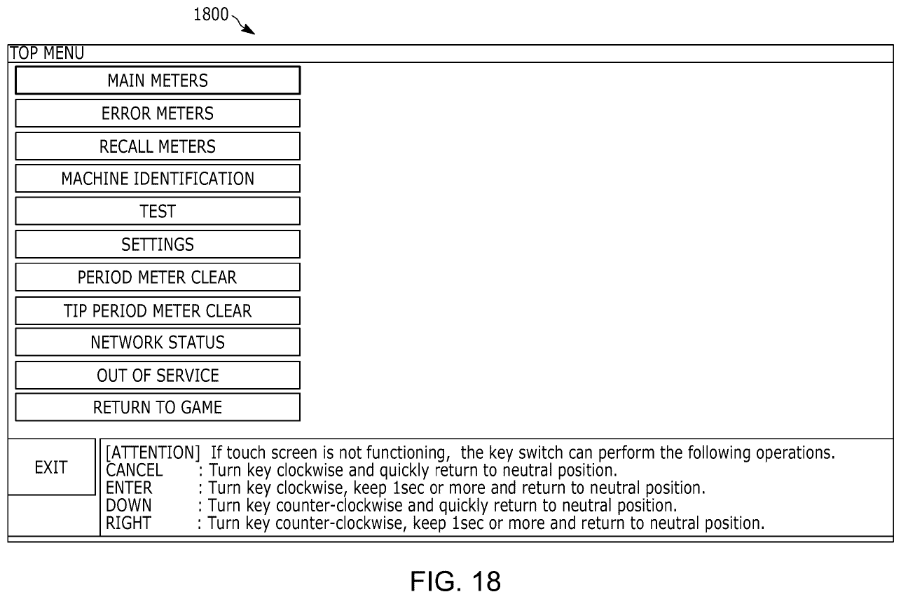

FIG. 18 illustrates an audit screen 1800 which is an accessible mode to provide information regarding the machine and gaming information. The audit screen 1800 may provide, for example, selections for information on main meters, error meters, recall meters, machine identification, test, settings, period meter clear, tip period meter clear, network status, out of service, and return to game.

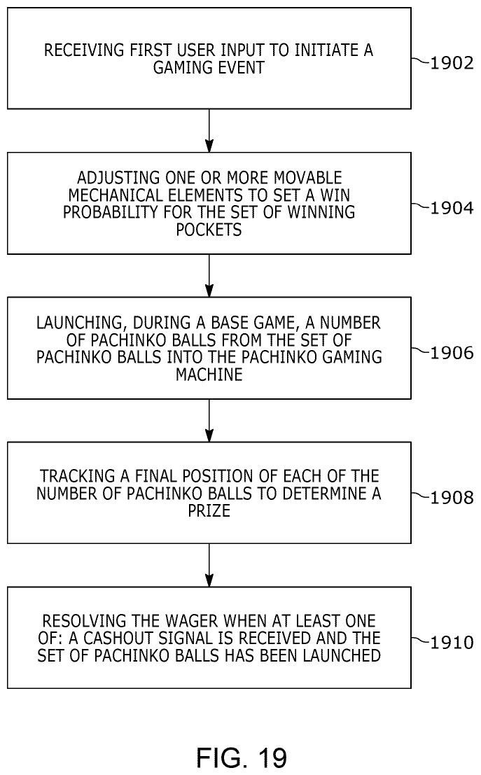

FIG. 19 illustrates a flow chart related to a pachinko gaming system and related operations. Various embodiments may include a pachinko gaming controller having at least one processor, and at least one memory communicatively coupled to the at least one processor and comprising computer-readable instructions can cause the at least one processor to perform various operations, such as operations 1902-1910. In some examples, the pachinko gaming controller establishes a connection with a game processor on a pachinko gaming machine.

At block 1902, aspects may receive, at an interactive interface connected to a pachinko gaming machine, first user input to initiate a gaming event. The first user input may include a wager for a set of pachinko balls. As discussed herein, the pachinko gaming machine may include an enclosed playing field, a set of winning pockets, and a plurality of movable mechanical elements affecting access to one or more winning pockets. The first user input is received via a peripheral device comprising at least one physical button to select the wager. In other examples, the first user input is received via the interactive interface, which may be a touch screen device or other computing device operable by the user.

At block 1904, aspects may adjust one or more movable mechanical elements to set a win probability for the set of winning pockets. The set of winning pockets may be, for example, a prize pocket, an attacker pocket, and a hidden pocket. As discussed herein, a movable mechanical element may be an electric tulip. The electric tulip may open during the bonus round to enable access to a hidden pocket. In other examples the mechanical element may be a bridge, which connects access to a hidden pocket during a bonus round. Some pachinko machines may have various types of movable elements. The movable elements may be managed by one or more of the game processor and the communications controller.

At block 1906, aspects may launch, during a base game, a number of pachinko balls, from the set of pachinko balls, into the pachinko gaming machine. The number of pachinko balls is determined from second player input received at the interactive interface. In some examples, a ball may launch after a player activates a peripheral, such as a handle or a button. However, despite the peripheral activation, the ball launch outcome is independent of the player action. Thus, outcomes may be randomized, e.g., according to a paytable. In some examples, at least one of a speed and a timing of the launch ball occurs independently of the player's control. The launch peripheral, such as a handle, may provide an appearance or feel of player control, without influencing an outcome of the ball launch.

At block 1908, aspects may track a final position of each of the number of pachinko balls to determine a prize. The prize may be awarded when at least one ball lands in a winning pocket. In examples, the prize is at least one of a bonus round, adding pachinko balls to the set, and a reel spin. During a bonus round, one or more movable mechanical elements may be adjusted to change the win probability for the set of winning pockets. In some examples, the bonus round increases a payout for any ball landing in one or more of the winning pockets.

In some examples, the player may wager on a side bet, such as a special bonus when a ball lands in a particular winning pocket. The special bonus may increase at least one of: a payout for at least one winning pocket and probability of landing in the at least one winning pocket. In other embodiments, when a pachinko ball lands in a winning pocket, the gaming machine may initiate at least one of a sound, an animation, and a video. Such audio, visual, or audiovisual features may capture a player's attention and generate excitement for the game.

At block 1910, aspects may resolve the wager when at least one of: a cashout signal is received at the interactive interface and the set of pachinko balls has been launched. In examples, resolving the wager includes converting the set of pachinko balls to a credit amount. Aspects may also print a ticket for prize redemption and update a player account. In additional examples, the pachinko gaming machine may generate a game summary on the interactive interface, the game summary providing one or more of: a total number of balls shot, a total number of balls won, an amount of balls received in a pocket type, a total prize won from each pocket type, a statistics associated with a past number of games.

The pachinko gaming machine may include an enclosed playing field, a reel display within the enclosed display, a launch device for launching a ball into the enclosed playing field, and an interactive display. In some examples, the pachinko gaming machine further includes a cabinet housing the communications controller, the enclosed playing field, the reel display, the launch device, and the interactive display. The communications controller may be secured within an interior portion of the cabinet, such as a locked interior portion. The pachinko gaming machine may also include a payment peripheral configured to receive at least one of: cash, a payment card, a token, and a player card, and wherein the communications controller establishes a third communication with the payment peripheral associated to resolve a wager received at the interactive display.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

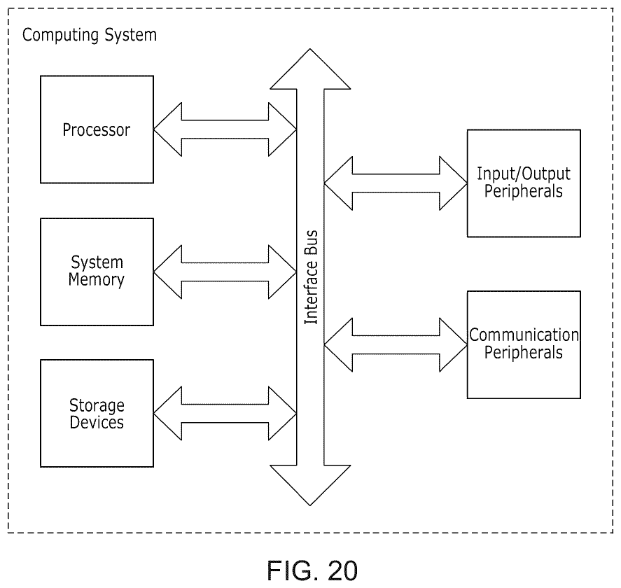

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 20 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

In an embodiment, a method for pachinko gaming, comprising: receiving, at an interactive interface connected to a pachinko gaming machine, first user input to initiate a gaming event, wherein the first user input comprises a wager for a set of pachinko balls, and wherein the pachinko gaming machine comprises an enclosed playing field, a set of winning pockets, and a plurality of movable mechanical elements affecting access to one or more winning pockets; adjusting one or more movable mechanical elements to set a win probability for the set of winning pockets; launching, during a base game, a number of pachinko balls, from the set of pachinko balls, into the pachinko gaming machine, wherein the number of pachinko balls is determined from second user input received at the interactive interface; tracking a final position of each of the number of pachinko balls to determine a prize, wherein the prize is awarded when at least one ball lands in a winning pocket, and the prize is at least one of a bonus round, adding pachinko balls to the set, and a reel spin; and resolving the wager when at least one of: a cashout signal is received at the interactive interface and the set of pachinko balls has been launched.

In an embodiment, further comprising, during the bonus round, adjusting the one or more movable mechanical elements to change the win probability for the set of winning pockets.

In an embodiment, wherein the bonus round increases a payout for any ball landing in the set of winning pockets.

In an embodiment, wherein the wager comprises a side bet, and the prize is a special bonus increasing at least one of: a payout for at least one winning pocket and probability of landing in the at least one winning pocket.

In an embodiment, wherein a movable mechanical element is an electric tulip.

In an embodiment, further comprising opening the electric tulip during the bonus round to enable access to a hidden pocket.

In an embodiment, further comprising: when a ball lands in a winning pocket, initiating at least one of a sound, an animation, and a video.

In an embodiment, wherein the first user input is received via a peripheral device comprising at least one physical button to select the wager.

In an embodiment, wherein the set of winning pockets comprises a prize pocket, an attacker pocket, and a hidden pocket.

In an embodiment, wherein at least one of a speed and a timing of each ball launch is independent of operation of a launch device.

In an embodiment, further comprising providing tactile feedback during operation of a launch device.

In an embodiment, a pachinko gaming system comprising: at least one processor; and at least one memory communicatively coupled to the at least one processor and comprising computer-readable instructions that upon execution by the at least one processor cause the at least one processor to perform operations comprising: receiving, at an interactive interface connected to a pachinko gaming machine, first user input to initiate a gaming event, wherein the first user input comprises a wager for a set of pachinko balls, and wherein the pachinko gaming machine comprises an enclosed playing field, a set of winning pockets, and a plurality of movable mechanical elements affecting access to one or more winning pockets; adjusting one or more movable mechanical elements to set a win probability for the set of winning pockets; launching, during a base game, a number of pachinko balls, from the set of pachinko balls, into the pachinko gaming machine, wherein the number of pachinko balls is determined from second user input received at the interactive interface; tracking a final position of each of the number of pachinko balls to determine a prize, wherein the prize is awarded when at least one ball lands in a winning pocket, and the prize is at least one of a bonus round, adding pachinko balls to the set, and a reel spin; and resolving the wager when at least one of: a cashout signal is received at the interactive interface and the set of pachinko balls has been launched.

In an embodiment, wherein resolving the wager comprises converting the set of pachinko balls to a credit amount.

In an embodiment, wherein resolving the wager comprises printing a ticket for prize redemption and updating a player account.

In an embodiment, further comprising: generating a game summary on the interactive interface, the game summary providing one or more of: a total number of balls shot, a total number of balls won, an amount of balls received in a pocket type, a total prize won from each pocket type, a statistics associated with a past number of games.

In an embodiment, a non-transitory computer readable medium comprising computer-executable instructions, which when executed cause: receiving, at an interactive interface connected to a pachinko gaming machine, first user input to initiate a gaming event, wherein the first user input comprises a wager for a set of pachinko balls, and wherein the pachinko gaming machine comprises an enclosed playing field, a set of winning pockets, and a plurality of movable mechanical elements affecting access to one or more winning pockets; adjusting one or more movable mechanical elements to set a win probability for the set of winning pockets; launching, during a base game, a number of pachinko balls, from the set of pachinko balls, into the pachinko gaming machine, wherein the number of pachinko balls is determined from second user input received at the interactive interface; tracking a final position of each of the number of pachinko balls to determine a prize, wherein the prize is awarded when at least one ball lands in a winning pocket, and the prize is at least one of a bonus round, adding pachinko balls to the set, and a reel spin; and resolving the wager when at least one of: a cashout signal is received at the interactive interface and the set of pachinko balls has been launched.

In an embodiment, further comprising adjusting, during the bonus round the one or more movable mechanical elements to change the win probability for the set of winning pockets.

In an embodiment, further comprising, during the bonus round, adjusting a position of the movable mechanical element to enable access to a hidden pocket.

In an embodiment, further comprising: when a ball lands in a winning pocket, initiating at least one of a sound, an animation, and a video.

In an embodiment, wherein the instructions, when executed, further cause determining the win probability according to a paytable received from the backend computing system and using a random number generator to control at least one of ball-launch timing, ball-launch speed, electric-tulip actuation, and access to a pocket.

As previously noted, the various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed:

1. A method for pachinko gaming, comprising:
receiving, at an interactive interface connected to a pachinko gaming machine, first user input to initiate a gaming event, wherein the first user input comprises a wager for a set of pachinko balls, and wherein the pachinko gaming machine comprises an enclosed playing field, a set of winning pockets, and a plurality of movable mechanical elements affecting access to one or more winning pockets;
adjusting one or more movable mechanical elements to set a win probability for the set of winning pockets;
launching, during a base game, a number of pachinko balls, from the set of pachinko balls, into the pachinko gaming machine, wherein the number of pachinko balls is determined from second user input received at the interactive interface;
tracking a final position of each of the number of pachinko balls to determine a prize, wherein the prize is awarded when at least one ball lands in a winning pocket, and the prize is at least one of a bonus round, adding pachinko balls to the set, and a reel spin; and
resolving the wager when at least one of: a cashout signal is received at the interactive interface and the set of pachinko balls has been launched.

2. The method of claim 1, further comprising, during the bonus round, adjusting the one or more movable mechanical elements to change the win probability for the set of winning pockets.

3. The method of claim 1, wherein the bonus round increases a payout for any ball landing in the set of winning pockets.

4. The method of claim 1, wherein the wager comprises a side bet, and the prize is a special bonus increasing at least one of: a payout for at least one winning pocket and probability of landing in the at least one winning pocket.

5. The method of claim 1, wherein a movable mechanical element is an electric tulip.

6. The method of claim 5, further comprising opening the electric tulip during the bonus round to enable access to a hidden pocket.

7. The method of claim 1, further comprising: when a ball lands in a winning pocket, initiating at least one of a sound, an animation, and a video.

8. The method of claim 1, wherein the first user input is received via a peripheral device comprising at least one physical button to select the wager.

9. The method of claim 1, wherein the set of winning pockets comprises a prize pocket, an attacker pocket, and a hidden pocket.

10. The method of claim 1, wherein at least one of a speed and a timing of each ball launch is independent of operation of a launch device.

11. The method of claim 1, further comprising providing tactile feedback during operation of a launch device.

12. A pachinko gaming system comprising:
at least one processor; and
at least one memory communicatively coupled to the at least one processor and comprising computer-readable instructions that upon execution by the at least one processor cause the at least one processor to perform operations comprising:
receiving, at an interactive interface connected to a pachinko gaming machine, first user input to initiate a gaming event, wherein the first user input comprises a wager for a set of pachinko balls, and wherein the pachinko gaming machine comprises an enclosed playing field, a set of winning pockets, and a plurality of movable mechanical elements affecting access to one or more winning pockets;
adjusting one or more movable mechanical elements to set a win probability for the set of winning pockets;
launching, during a base game, a number of pachinko balls, from the set of pachinko balls, into the pachinko gaming machine, wherein the number of pachinko balls is determined from second user input received at the interactive interface;
tracking a final position of each of the number of pachinko balls to determine a prize, wherein the prize is awarded when at least one ball lands in a winning pocket, and the prize is at least one of a bonus round, adding pachinko balls to the set, and a reel spin; and
resolving the wager when at least one of: a cashout signal is received at the interactive interface and the set of pachinko balls has been launched.

13. The pachinko gaming system of claim 12, wherein resolving the wager comprises converting the set of pachinko balls to a credit amount.

14. The pachinko gaming system of claim 12, wherein resolving the wager comprises printing a ticket for prize redemption and updating a player account.

15. The pachinko gaming system of claim 12, further comprising: generating a game summary on the interactive interface, the game summary providing one or more of: a total number of balls shot, a total number of balls won, an amount of balls received in a pocket type, a total prize won from each pocket type, a statistics associated with a past number of games.

16. A non-transitory computer-readable medium comprising computer-executable instructions, which when executed cause:
receiving, at an interactive interface connected to a pachinko gaming machine, first user input to initiate a gaming event, wherein the first user input comprises a wager for a set of pachinko balls, and wherein the pachinko gaming machine comprises an enclosed playing field, a set of winning pockets, and a plurality of movable mechanical elements affecting access to one or more winning pockets;
adjusting one or more movable mechanical elements to set a win probability for the set of winning pockets;
launching, during a base game, a number of pachinko balls, from the set of pachinko balls, into the pachinko gaming machine, wherein the number of pachinko balls is determined from second user input received at the interactive interface;
tracking a final position of each of the number of pachinko balls to determine a prize, wherein the prize is awarded when at least one ball lands in a winning pocket, and the prize is at least one of a bonus round, adding pachinko balls to the set, and a reel spin; and
resolving the wager when at least one of: a cashout signal is received at the interactive interface and the set of pachinko balls has been launched.

17. The non-transitory computer-readable medium of claim 16, wherein the instructions, when executed further cause adjusting, during the bonus round, the one or more movable mechanical elements to change the win probability for the set of winning pockets.

18. The non-transitory computer-readable medium of claim 16, wherein the instructions, when executed further cause, during the bonus round, adjusting a position of the one or more movable mechanical elements to enable access to a hidden pocket.

19. The non-transitory computer-readable medium of claim 16, f wherein the instructions, when executed, further cause, when a ball lands in a winning pocket, initiating at least one of a sound, an animation, and a video.

20. The non-transitory computer-readable medium of claim 14, wherein the instructions, when executed, further cause determining the win probability according to a paytable received from the backend computing system and using a random number generator to control at least one of ball-launch timing, ball-launch speed, electric-tulip actuation, and access to a pocket.
